(19) United States
(12) Patent Application Publication
(10) Pub. No.: US 2008/0227049 A1
(43) Pub. Date: Sep. 18, 2008

(54) Lingual Retainer

(76) Inventor: Habib Sevinc, Den Haag (DE)

Correspondence Address: NEXSEN PRUET, LLC, P.O. BOX 10648, GREENVILLE, SC, 29603, US

(21) Appl. No.: 11/997,891

(22) PCT Filed: Jul. 6, 2006
(86) PCT No.: PCT/EP06/06586

§ 371 Date: Feb. 4, 2008

(30) Foreign Application Priority Data
Aug. 4, 2005 (DE) 10 2005 036 678.3

(51) Int. Cl. A61C 7/08

(52) U.S. Cl. 433/6

(57) ABSTRACT

The invention relates to a retaining unit (lingual retainer) for Orthodontic treatment in particular for treating incisors (4 to 7) of lower and/or upper jaws, in particular for avoiding the return for formation a tertiary front overlapping by means of a tension element which is pasted (adhesive point 12) to each tooth (2 to 7) and forms a plastic shaped component (8) compatible with a mouth cavity.

The invention relates to a retention unit (lingual retainer) for orthodontic treatment of teeth, in particular incisors, of the lower jaw and/or upper jaw, in particular for avoiding a relapse or the development of tertiary front crowding, having a stretching element that is individually bonded to the teeth.

Such lingual retainers are known and are described on the Internet under “Lingual retainers” at http://www.smileclub.de/retainer.htm.

In this lingual retainer the stretching element comprises a round, multi-stranded stretching wire that has a diameter of approximately 0.5 mm. This steel wire is individually bonded to the inner surfaces of the teeth, preferably the incisors and the canines.

The problem arises here that the steel wire must not be bonded to the teeth too far outwardly toward the edges, so that it does not come into contact with edges of the opposing teeth of the upper jaw or lower jaw, interfere with chewing or become separated. On the other hand, it must not be led too far inwardly, so that it does not injure the gingiva of the teeth. This is a problem particularly because the gingiva between the two center incisors stands out farther toward the edges of the teeth than in the case of the other teeth. What is more, the steel wire is difficult to handle because it is not stable in its shape.

Because the retainer and thus also the steel wire should remain attached to the teeth for a plurality of years, as a rule four to five years and in some cases even longer, the problem arises that the steel wire corrodes.

As a consequence and because of the linking of the stretching element, the problem arises that the steel wire fractures between teeth and the action of the retainer is lost or impaired.

It is an object of the invention to remedy these disadvantages and furnish a retaining unit, lingual retainer, that remedies the previously described disadvantages, permits good adaptation to the teeth and good attachment to the teeth, and ensures a high degree of stability between the teeth.

The object of the invention is achieved in that the stretching element is fashioned as a molding and fabricated from plastic compatible with the mouth cavity.

As a consequence, the problems of corrosion are obviated, the fashioning of the stretching element as a molding also resulting in good adaptation to the teeth or to the inner surfaces of the teeth. The strength of the plastic here can be adapted to the circumstances.

In further development of the invention it is proposed that the molding is made in strip form and adapted to the configuration of the teeth.

The molding is advantageously shaped, in particular twisted or wound, to match the inner tooth surfaces of the teeth to which it is bonded. As a consequence, the molding has the shape adapted to the inner surfaces of the teeth in question even before bonding to the teeth, so that, as appropriate, only the ends of the molding need to be shortened to accord with the size of the jaw, because the central piece of the molding is adapted to the teeth.

In further development of the invention it is proposed that the molding exhibits a bowed piece in the transition region between the central incisors. The bowed piece is shaped outwardly toward the edges of the incisors and/or toward the incisors, and specifically so that it is adapted to the inner surfaces of the central incisors and moreover takes account of the fact that the gingiva between these two teeth stands farther outwardly.

The bowed piece is likewise made in strip form and is fashioned in one piece with the molding with the use of flexed transitions. As a consequence, the bottom piece forms a central fixation of the molding between the central incisors so that the position of the molding inside the teeth is unambiguously defined.

For further explanation of the invention, reference is made to an exemplary embodiment of the invention illustrated in simplified form in the Drawings, in which:

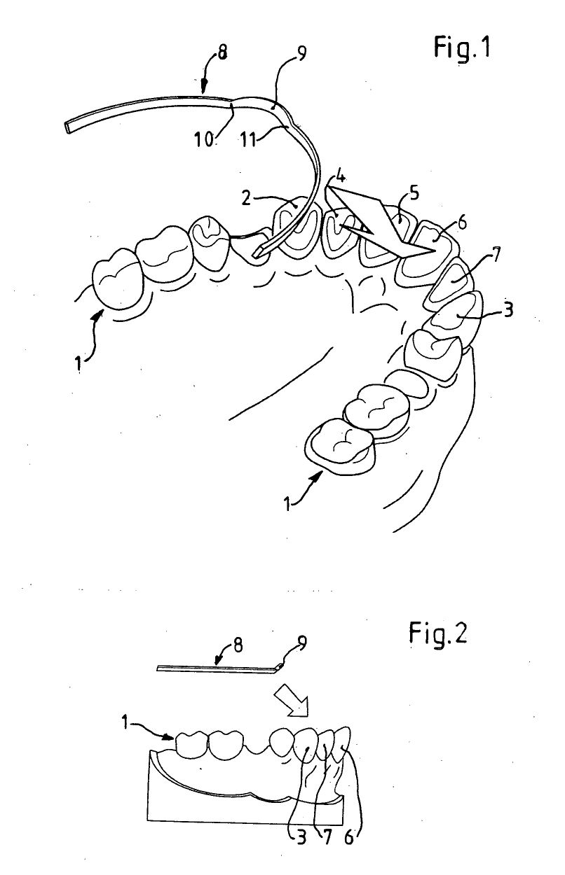

FIG. 1 is a perspective representation of a jaw with a row of teeth and a molding before its attachment to the teeth;

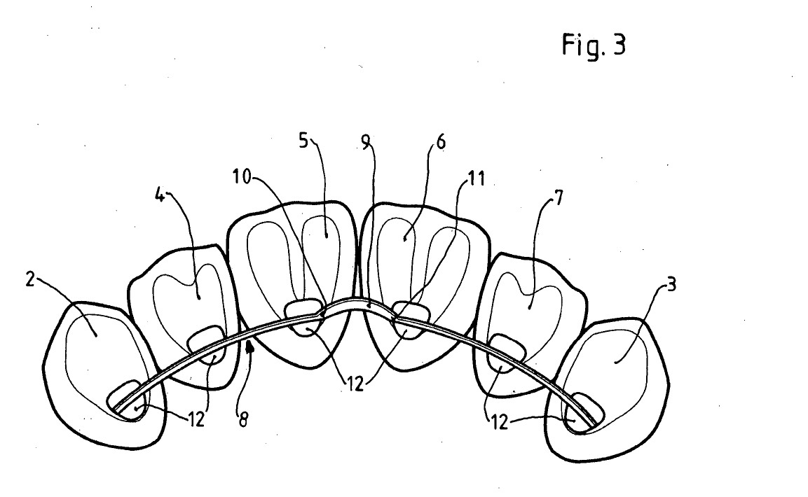

FIG. 2 is a lateral view of a jaw model with teeth and a separate molding; and

FIG. 3 is an oblique top view of the inner tooth surfaces with bonded molding.

In FIGS. 1 to 3, insofar as illustrated in detail, reference character 1 identifies a row of teeth; 2 and 3, canines; and 4 to 7, incisors.

Reference character 8 identifies a molding that is provided for attachment to the teeth, in particular canines 2 and 3 and incisors 4 to 7. Molding 8 is fashioned in strip form and exhibits in the middle a bowed piece 9, which is fabricated in one piece with the remaining parts of molding 8 with the use of flexed transitions 10 and 11. Molding 8 including bowed piece 9 is so shaped that it is adapted to the inner tooth surfaces of the corresponding teeth, in particular canines 2 and 3 and incisors 4 to 7. It can therefore be laid against the inner surfaces of the teeth without further manipulations and difficult handling and attached to the teeth by bonding points 12.

### LIST OF REFERENCE CHARACTERS

1 Row of teeth

2 Canine tooth

3 Canine tooth

4 Incisor

5 Incisor

6 Incisor

7 Incisor

8 Molding

9 Bowed piece

10 Flexed transition

11 Flexed transition

12 Bonding points

1-6. (canceled)

7. A retention unit for orthodontic treatment of incisors avoid a relapse or the development of tertiary front crowding comprising:
a stretching element bonded to each of said incisors including at least a central pair, wherein the stretching element is fashioned as a molding and fabricated from plastic compatible with the mouth cavity.

8. The retention unit of claim 7, wherein said molding is made in strip form and adapted to the configuration of said incisors.

9. The retention unit of claim 7, wherein said molding is shaped to match the inner tooth surfaces of said incisors to which it is bonded.

10. The retention unit of claim 8, wherein said molding is shaped to match the inner tooth surfaces of said incisors.

11. The retention unit of claim 7, wherein said molding is a bowed piece in the transition region between said central pair of said incisors.

12. The retention unit of claim 8, wherein said molding is a bowed piece in the transition region between said central pair of incisors.

13. The retention unit of claim 9, wherein said molding is a bowed piece in the transition region between said central pair of incisors.

14. The retention unit of claim 11, wherein said molding is bowed piece in the transition region between said central pair of incisors.

15. The retention unit of claim 10, wherein said bowed piece is shaped outwardly toward the edges of said central incisors.

16. The retention unit of claim 10 wherein the bowed piece is made in strip form and is fashioned in one piece with the molding by the use of flexed transitions.
